(19) United States
(12) Patent Application Publication
(10) Pub. No.: US 2019/0309644 A1
(43) Pub. Date: Oct. 10, 2019

(54) ELECTRICAL POWER GENERATION ASSEMBLY HAVING RECOVERY GAS EFFICIENCY

(71) Applicant: Elysium Solutions LLC, Buckeye, AZ (US)

(72) Inventor: Ryan M. Doherty, Buckeye, AZ (US)

(73) Assignee: Elysium Solutions LLC, Buckeye, AZ (US)

(21) Appl. No.: 15/949,362

(22) Filed: Apr. 10, 2018

(51) Int. Cl. F01D 15/10; H02K 7/18

(52) U.S. Cl. CPC F01D 15/10; F05D 2220/76; F05D 2220/62; H02K 7/1823

(57) ABSTRACT

An electric generation assembly for generating electricity in an efficient manner using a recovery gas flow is provided. The electric generation assembly may comprise a rotating stator rotated by a prime mover, such as a gas or steam turbine. A rotor may be rotatably positioned within the rotating stator, wherein the rotation of the rotor is counter to the rotation of the rotating stator. The electric generation assembly may also comprise a heat recovery generator, wherein the rotating stator and the rotor are seated within the heat recovery generator. During operation when the rotating stator and the rotor generate electricity, the heat generated by the stator and the rotor can be recovered using a flow of gas that passes through the heat recovery generator, the rotor and the stator to produce a recovery gas flow, which can be used as a prime mover to rotate the rotor and conserve energy.

### BACKGROUND

In this age of explosive information and data, various companies look to the conservation of fuel and electricity to generate more economic value within electric and mechanical systems. Nearly all of the power in our nation's electric power grids is supplied by electric generators. These conventional electric generators are devices that convert mechanical energy into electrical power for use in an external circuit. Several sources of mechanical energy may be used to generate electric current, including but not limited to steam turbines, gas turbines, water turbines, internal combustion engines, hand cranks and the like. These generators may be used in nuclear power plants to produce electricity, wherein heat from a nuclear reactor is used to drive a steam turbine that is coupled to the electric generator.

Since its inception, the electromagnetic design for the electric generator typically comprises a stationary component (stator) and a rotating component (rotor). The rotor is rotatably coupled to the stator, wherein the rotor rotates around a center axis. The stator may comprise a number of stator windings axially extending in freely exposed end windings. Particularly, in an effort to generate three-phase alternating-current (AC) power, a three-phase AC generator may use a rotor assembly having a magnetic field, which is rotated within a stator assembly having a three-phase winding, in accordance with the law of electromagnetic induction.

Conventional designs for electric generators, however, only employ one method of generating electricity, wherein there is a rotating magnetic field, which is surrounded by a cage of conductors that form a conductor assembly. The stationary component is typically always this conductor assembly. In particular, the rotor assembly comprises a set of fixed magnets having a magnetic field, which are affixed a to rotating shaft. These fixed magnets possess a naturally occurring magnetic strength and magnetic field, which do not change. In some embodiments, when the magnetic field of the rotor cuts through the conductor assembly, electric current is generated. In other designs, the stator includes an electro-magnet having an adjustable voltage. In both designs, however, the process for generating electricity is inefficient. Particularly, during the production of electricity within an electrical generator, heat is generated by an armature of the rotor assembly. Current designs for electrical generators remove this heat to an unrecoverable medium. For example, some conventional generators use gas, coolants, or water-cooling elements that remove heat from the stator and rotor assembly. This removal of heat, however, represents a wasted resource of energy.

Further, typical electrical transmission of electricity to or from rotating components of the rotor assembly, such as exciter voltage to an armature, or output transmission of motor generators, is by way of carbon brushes and slip rings. Yet, the greater the number of components that exist within the process for electrical transmission increases the chances for a greater loss of energy that can exist within the system.

It is within this context that the embodiments arise.

### SUMMARY

Embodiments of an electrical power generation assembly having an efficient manner of electric generation that uses a recovery gas flow are provided. It should be appreciated that the present embodiment can be implemented in numerous ways, such as a process, an apparatus, a system, a device, or a method. Several inventive embodiments are described below.

In some embodiments, an electrical power generation assembly having recovery gas efficiency may comprise a rotating stator rotated by a prime mover, such as a gas or steam turbine. A rotor may be rotatably positioned within the rotating stator, wherein the rotation of the rotor is counter to the rotation of the rotating stator. The electrical power generation assembly may also comprise a heat recovery generator, wherein the rotating stator and the rotor are seated within the heat recovery generator. During operation when the rotating stator and the rotor generate electricity, the heat generated by the stator and the rotor can be recovered using a flow of gas that passes through the heat recovery generator, the rotor and the stator to produce a recovery gas flow, which can be used as a prime mover to rotate the rotor and conserve energy.

In some embodiments, a system and method for generating electricity in an efficient manner using a recovery gas flow is provided. The method may include supplying a gas flow to a gas entry assembly having a first cavity. The method may further include receiving the gas flow by an electrical power generation assembly into a second cavity from the gas entry assembly, the second cavity for propagation of the gas flow to recover the heat generated by the electrical power generation assembly. Further, the method may include rotating the electrical power generation assembly within the gas entry assembly; wherein, the heat generated by the electrical power generation assembly is transferred to the gas flow to supply a recovery gas flow. Finally, the method may include receiving the recovery gas flow into a gas exit assembly having a third cavity for transferring the recovery gas flow to an external device as a means of supplied energy.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one so skilled in the art without departing from the spirit and scope of the described embodiments.

FIG. 1 is a perspective view of an electrical power generation assembly with recovery gas flow efficiency, in accordance with some embodiments.

FIG. 2 is a cross-sectional view of the electrical power generation assembly of FIG. 1 in accordance with some embodiments.

FIG. 3 is a perspective view of an electrical power generation assembly with recovery gas flow efficiency having transmission rings, in accordance with some embodiments.

FIG. 4 is a flow diagram of a method for generating electricity in an efficient manner using recovery gas flow in accordance with some embodiments.

### DETAILED DESCRIPTION

The following embodiments describe a system and method for generating electricity in an efficient manner using recovery gas flow. It can be appreciated by one skilled in the art, that the embodiments may be practiced without some or all of these specific details. In other instances, well known process operations have not been described in detail in order not to unnecessarily obscure the embodiments.

The electrical power generation assembly having recovery gas efficiency provided herein may comprise a rotating stator rotated by a prime mover, such as a gas or steam turbine. Further, a rotor may be rotatably positioned within the rotating stator, wherein the rotation of the rotor is counter to the rotation of the rotating stator, which reduces the necessary power to generate electricity enabling a more efficient design. Thereby, the rotating rotor produces change in the magnetic flux to produce electrical current in the rotating stator. The electric generation assembly may also comprise a heat recovery generator, wherein the rotating stator and the rotor are seated within the heat recovery generator. During operation when the rotating stator and the rotor generate electricity, the heat generated by the stator and the rotor can be recovered using a flow of gas that passes through the heat recovery generator to produce a recovery gas flow. Accordingly, this recovery gas flow can be used as a prime mover to rotate the rotor and conserve more energy in various other external parts of a system that comprises the electrical power generation assembly.

The electrical power generation assembly is designed to recover the inefficiencies of current electric generators and those of the past. As known to those skilled in the art, electricity requires a specific speed of rotation of the armature to produce a specific frequency and voltage. When there are two rotating components rotating opposite each other that speed is reduced. Hence, the fuel required to produce that speed will also reduce. Thereby, the novel design of the electrical power generation assembly disclosed herein conserves energy in two ways. First, it requires a smaller amount of fuel to run than conventional electric generators. Second, the electric generation assembly uses the heat that is generated during the process of electricity generation to provide energy to other parts of the system incorporating the electrical power generation assembly. In particular, the recovery gas flow can be used to produce rotation of the rotor. More particularly, the electrical generator assembly described herein can recover the heat generated by the rotor and stator, compress this recovery gas flow, and then, return this gas flow to drive the rotating armature. In the alternative, the recovery gas flow may be used to produce rotation of the stator in lieu of a prime mover. Thereby, this electrical power generation assembly can recover wasted energy and put it back into the process or other areas of the system.

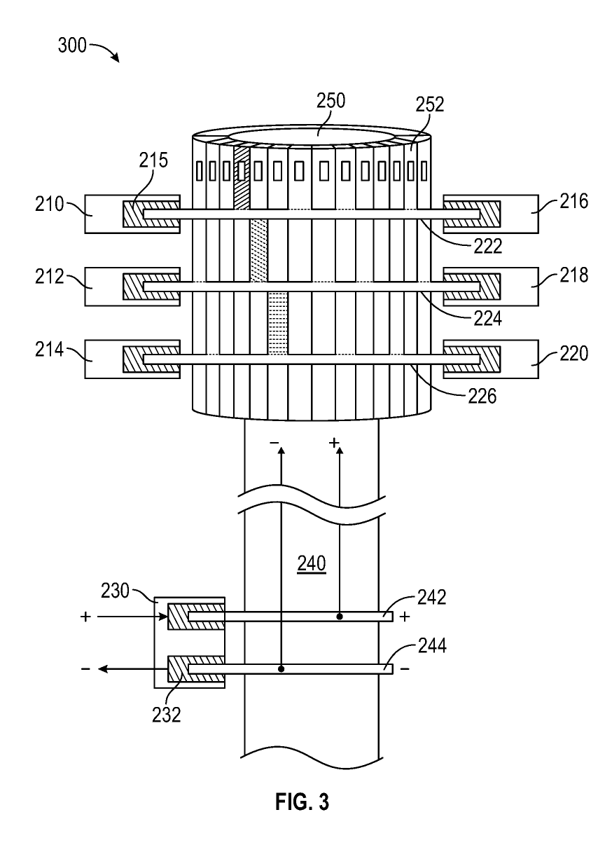

Further, the electrical power generation assembly described herein may incorporate the use of a plurality of transmission rings coupled to the rotating stator and the rotor as opposed to commutators, carbon brushes, and slip rings. This supports a more efficient design. One set of rings may rotate with the shaft coupled to the armature, providing DC input to produce an electromagnetic field on the armature. Another set of rings may rotate with the conductor assembly providing electrical output, wherein each ring is in contact with the associated phase of the AC current and electrically insulated from the other phases (to be explained in more detail with reference to FIG. 3). For each of the sets of rotating rings, a set of stationary rings may indirectly couple with the rotating rings, wherein electricity can be transferred between the rotating and stationary rings by way of an electrically conductive fluid or similar medium. These stationary rings can be either connected to an output bus (associated with the conductor assembly) or an exciter voltage supply (associated with the rotor assembly).

Advantageously, instead of wasting the heat generated by the production of electricity as in conventional designs, the electrical power generation assembly described herein uses a flow of gas within the electrical power generation assembly that recovers this heat and uses it for other purposes of power supply within the system.

The novel design of the electrical power generation assembly described herein may be used in a great variety of applications. Regarding aviation, the electrical power generation assembly described herein can be used in place of conventional electrical generators to produce more electricity within an auxiliary propulsion power unit, which utilizes drag to create electricity. In the automotive industry, alternators may be redesigned using the novel features of the electrical generator described herein to produce more electricity. Hybrid vehicles may incorporate the features of the novel design for the electrical power generation assembly described herein to produce more electricity for use as momentum captured while coasting in a regenerative breaking mode of operation. Any device that has a prime mover, which generates electricity, can use the electrical power generation assembly described herein. Although most methods for efficient design of an electrical generator focus upon the fuel consumption and consuming fuel, this generator conserves energy independent of its attached prime mover. This electrical power generation assembly could enable nuclear power plants to produce more economically feasible electricity on their own without the undue expense associated with fuel. The novel design of the electrical power generation assembly described herein may also enable providers that supply power for the local electrical power grid to supply more power on the grid at a greater economical value.

In the following description, numerous details are set forth. It will be apparent, however, to one skilled in the art, that the present embodiments may be practiced without these specific details. In some instances, well-known structures and devices are shown in block diagram form, rather than in detail, in order to avoid obscuring the inventive concepts disclosed.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

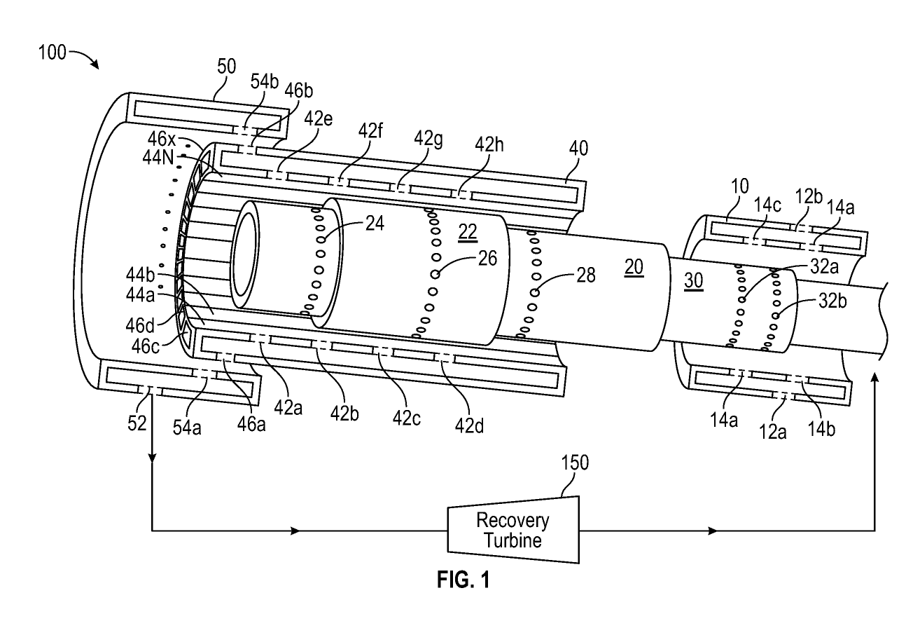

Referring to FIG. 1, a perspective view of an electrical power generation assembly 100 with recovery gas flow efficiency, in accordance with some embodiments is shown. The electrical power generation assembly includes a stator assembly 40, a rotor assembly 20 having a shaft 30, and a heat recovery generator including a gas entry assembly 10 and a gas exit assembly 50. The gas entry assembly 10 and gas exit assembly 50 can be comprised of stationary housing for the circulation of gas flow through the electric generation assembly 100. As shown, the entry assembly 10 includes, at least one gas inlet port 12(a, b) and a plurality of gas exit ports (14a , 14b , 14c , and 14d ). Although four gas exit ports are shown, there may be any number of a plurality of gas exit ports (1-P) in the electric generation assembly disclosed herein. The cylindrical shaft 30 may couple to the cylindrical rotor assembly 20 including an armature 22. A plurality gas inlet ports (24, 28) are included in the rotor assembly 20 at its ends. Further, a plurality of gas inlet ports 26 may be included in the armature 22. The rotor assembly 20 can be rotatably coupled to a stator or conductor assembly 40, wherein the rotor assembly 20 rotates counter to the rotation of the conductor assembly 40. The conductor assembly 40 includes a plurality of conductor elements 44a -44N. In particular, there can be any number of conductor elements 44 in the electrical power generation assembly 100 disclosed herein. The number of conductor elements 44 depends upon the design of the conductor assembly 40. Each of the conductor elements 44 may include gas inlet ports 42(a-h) and gas exit ports 46(a-X). The gas exit assembly 50 may couple to receive the gas flow from the gas exit ports 46(a-X). In particular, the gas exit assembly 50 may include a gas inlet port 54(a, b) and a gas outlet port 52 located within the exterior and interior surfaces of the gas exit assembly 50. Although the conductor assembly 40, the rotor assembly 20 and a heat recovery generator assembly (10 and 50) are shown to have a cylindrical shape, the shape either of these assemblies can be configured in a great variety of geometric patterns, including but not limited to spherical, triangular, hexagonal, rectangular, and the like. Further, the dimension and size of the stator assembly 40, the rotor assembly 20 and a heat recovery generator assembly (10 and 50) may be in accordance with the size of each component in relation to one another. As shown, the entry assembly 10 can be smaller in circumference than the exit assembly 50 to accommodate for the size of the shaft 30 and the stator assembly 40, respectively. The components of the electrical power generation assembly 100 may be made of a great variety of materials. In particular, the conductor assembly 40, the rotor assembly 20 and a heat recovery generator assembly (10 and 50) may be made of various metals, plastics, glass, or any combination thereof. For example, the stator assembly 40, the rotor assembly 20 and a heat recovery generator assembly (10 and 50) may be made of steel, aluminum, or tungsten.

In operation, the gas flow enters into the gas inlet port 12(a, b) of the entry assembly 10, circulating through the entry assembly 10 and exiting out of the exit ports 14(a-d). A turbine (not shown) may be used to provide the necessary torque to turn shaft 30 in a clockwise direction. Accordingly, rotor assembly 20 can be rotated in either direction. For example, rotor assembly 20 can be rotated in a clockwise direction, while the gas flow propagates through the shaft 30 up towards the rotor assembly 20. At the same time, the stator assembly 40 may be rotated in a counter-clockwise direction preserving the amount of energy necessary to generate electricity. As noted supra, electric generation requires a specific speed of rotation of the armature to produce a specific frequency and voltage. When there are two rotating components (i.e. rotor assembly 20 and stator assembly 40) rotating opposite each other the amount of speed required to produce electricity is reduced. Hence, the fuel or steam from a primary mover necessary to rotate the stator assembly 40 will also be reduced. Thereby, the rotation of both the rotor assembly 20 and the stator assembly 40 conserves energy directly associated with a prime mover. In addition, during the production of the electricity by way of the rotor assembly 20 rotating within the stator assembly 40, the gas flow extracts the heat from the rotor assembly 20. As known by those skilled in the art, an armature 22 produces heat simultaneously when it produces an electromagnetic field. The gas flow traverses past the armature 22 and removes this heat from the armature 22. Consequently, the heated gas flow (also known as, recovery gas flow) exits out of the armature 22 comprised within the rotor assembly 20, through the plurality of gas exit ports 26. The recovery gas flow also exits out of gas exit ports 24 and 28 located with the rotor assembly 20. The gas flow proceeds its course through the stator assembly 40 having conductor elements 44(a-N). In particular, the gas enters into the plurality of gas inlet ports 42(a-h) and circulates throughout the stator assembly, wherein the recovery gas flows through each conductor element 44(a-N) simultaneously. The recovery gas flow leaves the stator assembly through the plurality exit ports 46(a-X) and enters the exit assembly 50 of the heat recovery generator to circulate through a final exit port 52. This recovery gas flow can be used to provide energy and power an external component within the system. For example, the excess energy can be harnessed to provide power for rotating the rotor assembly 20. In the alternative, the excess energy can be harnessed to provide power for rotating the stator assembly 40.

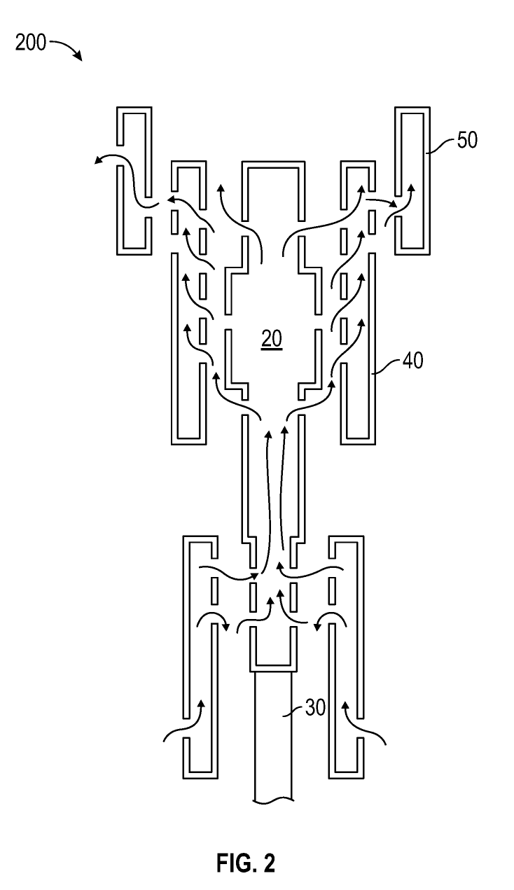

Referring to FIG. 2, a cross-sectional view of the electric generation assembly of FIG. 1 in accordance with some embodiments is shown. As known to those skilled in the art, generators generate heat during the process of generating electrical current. One novel design feature of the electrical generator assembly described herein may use any type of gas to harness this heat and use this captured energy for other parts of the same system or another system. For example, the electrical generator assembly may use any type of gas, including the air surrounding the unit, hydrogen, cryogenic gas, and the like. As illustrated, the general flow path of the recovery gas goes through the entry assembly 10 and the shaft 30, which traverses up through the rotor assembly 20 and into the stator assembly 40. In some embodiments, the shaft 30 can be hollow, having output ports in the center directed to the bottom of the conductor elements 44. The shaft may also have ports on one of the outboard ends, to allow for the cooled off recovery gas to enter the shaft. This cooled gas flow is then enabled to exit through the exit ports in the center of the shaft. The stator assembly 40 represents the first rotating component having conductor elements. The stator assembly 40 can be driven by a fuel consumer, including a gas engine, steam turbine, gas turbine, and the like. In some embodiments, this fuel consumer can rotate this first rotating component, wherein the fuel consumer is the prime mover. Rotor assembly 20 represents the second rotating component that contains an electromagnetic field, which rotates on a shaft wherein it is surrounded by the conductor elements of the stator assembly 40. The rotor assembly 20 can be driven by the recovered heat of generation using the gas flow and a recovery turbine that runs strictly off of the recovered energy from the process. As shown in FIG. 1, the gas flow can be channeled through each conductor element 44 within the stator assembly 40. The rotating conductor elements 44 can be hollow, having a plurality of ports for the gas to flow in and out of its cavity. In some embodiments, the ports can be located near the on the top and bottom ends of each element and at the center of each element, such that the flow of gas is directed at the armature. The rotating conductor elements 44 can have ports on one out-board end, for the newly heated recovery gas to exit each conductor element 44. In some embodiments, each conductor element 44 can have a separate channel cavity for the gas to flow throughout, such that gas goes through the entire assembly 40 removing heat from the stator assembly 40. Finally, the gas flow proceeds through the exit assembly 50 to be used as excess energy for other parts of the system or to provide energy to rotate either the stator or rotor assembly.

Referring to FIG. 3, a perspective view of a electrical power generation assembly 200 with recovery gas flow efficiency having transmission rings, in accordance with some embodiments is shown. In particular, stator assembly 250 may include transmission rings (222, 224, and 226) coupled around the stator assembly 250. The transmission rings (222, 224, and 226) rotate with the corresponding coupled conductor elements 252 of the stator assembly 250. In a symmetric three-phase power supply system, three conductor elements 252 each carry an alternating current of the same frequency and voltage amplitude relative to a common reference, yet with a phase difference of one third the period. The common reference is usually connected to ground and often to a current-carrying conductor called the neutral. Due to the phase difference, the voltage on any conductor element 252 reaches its peak at one third of a cycle after one of the first phase associated other the conductor elements and one third of a cycle before the third phase conductor. This phase delay gives constant power transfer to a balanced linear load. It also makes it possible to produce the rotating magnetic field in the electrical power generation assembly 200. As indicated by the shading, there are three phases (A, B, C) associated with the conductor, wherein phase A is represented by diagonal lines angled to the right, phase B is represented by dotted diagonal lines angled to the left and phase C is represented by horizontal dotted lines. As shown, every third bar is essentially a differing phase. Each transmission ring (222, 224, and 226) is only in contact with the associated phase of the conductor and is electrically insulated from the other phases. For example, transmission ring 222 may be coupled to conductor elements 252 associated with phase A and electrically isolated from those conductor elements 252 that are associated with phases B and C. Additionally, three stationary pairs of transmission rings (200, 216, 212, 218, 214, and 220) may indirectly couple to transmission rings (222, 224, and 226) through a conductive medium (represented by diagonal lines, angled to the left). For example, the gap between the stationary and rotating discs may include an electrically conductive fluid (or conductive grease) having highly conductive metal particles that stand up to high temperatures and high pressure, such as aluminum, silver, gold, copper, and the like. Accordingly, these rotating transmission rings (222, 224, and 226) serve as electrical output, wherein the stator assembly 250 produces electricity for the electric generator assembly 200.

Further, transmission rings 242 and 244 may couple around the shaft 240, which couples to the rotor assembly (not shown) rotatably coupled inside of the stator assembly 250. A dual input stationary transmission ring portion 230 may indirectly couple to transmission rings (242 and 244) through a conductive medium 232. For example, similar to the conductive fluid noted above, the gap between the stationary transmission ring portion 230 and rotating transmission rings 242 and 244 may include an electrically conductive fluid (or conductive grease) having highly conductive metal particles that stand up to high temperatures and high pressure, such as aluminum, silver, gold, copper, and the like. Accordingly, the dual input stationary transmission ring portion 230 coupled to the rotating transmission rings (242 and 244) can serve as electrical input to the electric generation assembly 200, wherein AC or DC input can be used as input to produce an electromagnetic field on the armature coupled to the shaft 240.

In operation, the transmission rings (222, 224, 226, 242, and 244) can simplify the electrical power generation assemblies' ability to transmit electricity. These transmission rings make the electrical power generation assembly 200 more efficient. Conventional electric generators include commutators, carbon brushes, slip rings, and the like. These excessive components account for more electrical losses within a system. Particularly, every time electricity is transferred from one component to the next, heat loss exists. With the transmission rings, there is only one transfer. As a result, the design of the electrical power generation assembly is more efficient and simplistic than the conventional electric generator. Further, maintenance for the electrical power generation assembly is significantly reduced. Common parts, such as the carbon brushes wear down frequently and need to be replaced often. However, transmission rings (222, 224, 226, 242, and 244) do not need to be replaced when the electrically conductive fluid degrades and the conductive fluid can be changed easily, which ordinary does not happen for a long period of time.

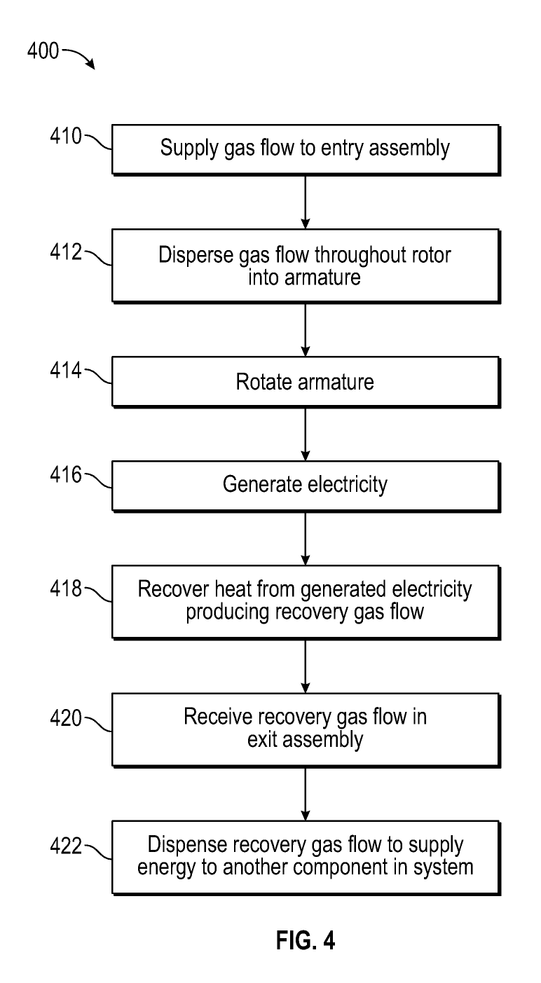

Referring to FIG. 4, a flow diagram of a method for generating electricity in an efficient manner using recovery gas flow in accordance with some embodiments is shown. In an action 410, the method may include supplying gas flow to an entry assembly. The method may further include dispersing gas flow throughout a rotor assembly into an armature in an action 412. For example, the entry assembly and the rotor assembly may include a cavity system that supports gas flow. In an action 414, the method may include rotating the armature. For example, a turbine may be used to provide the necessary torque to turn a shaft coupled to the rotor assembly in a clockwise direction. Electric current may be generated in an action 416. In particular, the rotor assembly may be rotatably coupled to a stator assembly, wherein, when the rotor assembly rotates it changes the magnetic flux associated with the stator assembly; thereby generating electric current. Further in an action 418, the method may include recovering heat from the generator assembly and producing a recovery gas flow. For example, the associated cavity within the rotor assembly may be positioned in such a way as to enable heat transfer from the armature to the gas flow, producing a recovery gas flow. Next, the method may include receiving the recovery gas flow from the exit assembly in an action 420. Finally, in an action 422, the method may include dispensing the recovery gas flow to supply energy to another component of the system. For example, the recovery gas flow may be sent to a compressor that sends the compressed gas to a turbine that provides the torque necessary to rotate the shaft of the electric generation assembly.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

1. An electrical power generation assembly for generating electricity in an efficient manner, wherein the electrical power generation assembly comprising:
a rotating stator rotated by a prime mover, the rotating stator having a stator housing that forms a first inner cavity, the stator housing comprises at least one port for gas flow;
a rotor rotatably positioned within the rotating stator, wherein the rotation of the rotor is counter to the rotation of the rotating stator, the rotor having a rotor housing that forms a second inner cavity, the rotor housing comprises at least one port for gas flow; and
a heat recovery generator, having a third inner cavity, the heat recovery generator coupled juxtapose to the rotating stator and the rotor, wherein the heat recovery generator couples to receive a gas flow that propagates through the first inner cavity and the second inner cavity to form a recovery gas flow having absorbed heat generated by the rotating stator and the rotor, wherein when a recovery turbine is coupled between the rotor and the heat recovery generator to receive the recovery gas flow, the rotor is rotated by the recovery turbine using energy generated by the recovery gas flow.

2. The electrical power generation assembly of claim 1, wherein the heat recovery generator comprises:
a gas entry assembly having a housing with a first hollow core, an exterior surface of the housing having at least one gas inlet port leading to the first hollow core for gas flow, and an interior surface of the housing having at least one gas outlet port; and
a gas exit assembly having a housing with a second hollow core, an interior surface of the housing having at least one gas inlet port leading to the second hollow core for recovery gas flow, and an exterior surface of the housing having at least one gas outlet port;
wherein the first hollow core and the second hollow core form the third inner cavity;
wherein, when gas is pumped through the gas flow entry assembly, the gas circulates through the first hollow core, the second inner cavity of the rotor, the first inner cavity of the rotating stator, and the second hollow core to exchange the heat generated by the electric generation assembly to external parts of an electrical system.

3. The electrical power generation assembly of claim 1, further comprising:
a plurality of rotating transmission rings coupled to the rotating stator, wherein each rotating transmission ring couples to the conductor elements associated with one phase of three phases;
a plurality of rotating transmission rings coupled to the rotor;
a plurality of stationary transmission rings positioned adjacent to the plurality of rotating transmission rings coupled to the rotating stator and the rotor; and
a conductive grease applied between the plurality of rotating transmission rings and the plurality of stationary transmission rings for transferring electricity between the rotating transmission rings to the stationary transmission rings.

4. The electrical power generation assembly of claim 1, wherein the rotating stator comprises, a plurality of conductor elements, each having an interior wall and an exterior wall, wherein the plurality of conductor elements coupled to one another to form a cylinder, the interior walls of each conductor element having at least one gas inlet ports, the exterior walls of each conductor element having at least one a gas outlet port;
wherein, the plurality of conductor elements comprise a three phase winding circuit to produce a rotating magnetic field having three phases;
a first transmission ring directly coupled to the plurality of conductor elements associated with a first phase of an alternating current;
a second transmission ring directly coupled to the plurality of conductor elements associated with a second phase of an alternating current;
a third transmission ring directly coupled to the plurality of conductor elements associated with a third phase of an alternating current;
wherein, the rotating stator generates electrical current as the plurality of conductor elements rotate with respect to the rotor; the first transmission ring being electrically coupled to the plurality of conductor elements, the first of transmission ring providing a connection point for electrical current corresponding to the first phase to flow from the rotating stator, the second of transmission ring providing a connection point for electrical current corresponding to the second phase to flow from the rotating stator, the third of transmission ring providing a connection point for electrical current corresponding to the third phase to flow from the rotating stator.

5. The electrical power generation assembly of claim 1, wherein the rotor comprises,
a housing;
a shaft member having a first end and a second end, the shaft rotatably positioned within the housing to rotate with respect to the stator;
a pair of transmission rings directly coupled to the second end of the shaft;
an armature coupled to the shaft member and extending towards the first end of the shaft, the armature for generating electrical current through an armature winding as the armature rotates with respect to the rotating stator; wherein the pair of transmission rings being electrically coupled to the armature, the pair of transmission rings providing a connection point for electrical current to flow to and from the armature.

6. The electrical power generation assembly of claim 2, wherein the diameter of the gas entry assembly is smaller than the diameter of the gas exit assembly.

7. The electrical power generation assembly of claim 2, wherein the gas flow entry assembly comprises,
a cylindrical-shaped housing with the first hollow core.

8. The electrical power generation assembly of claim 2, wherein the gas flow exit assembly comprises,
a cylindrical-shaped housing with the second hollow core.

9. The electrical power generation assembly of claim 1, further comprising:
an anti-rotation device coupled to the rotor for preventing the rotor from rotating in two directions.

10. An electrical power generation assembly for generating electricity in an efficient manner, wherein the electrical power generation assembly comprising:
a gas entry assembly having a cylinder-shaped housing, the cylinder-shaped housing having an outer wall that forms a hollow core, wherein the outer wall having a gas inlet port through an interior surface of the outer wall leading to an inner cavity and a gas outlet port;
an electrical power generation assembly being adapted for converting rotational motion into electrical energy, the electrical power generation assembly generator assembly comprises a rotor assembly and a rotating stator assembly, the rotor assembly having a magnetic field and a wire winding, wherein when the rotor assembly rotates within the rotating stator assembly, a changing magnetic field is generated and the changing field induces a voltage on the rotating stator;
wherein the rotating stator assembly having a cylinder-shaped housing, the cylinder-shaped housing having an outer wall that forms a hollow core, wherein the outer wall having a plurality of gas inlet ports through an interior surface leading to an inner cavity and having a pair of gas outlet ports through an exterior surface;
wherein the rotor assembly comprises:
a shaft member having a hollow core and a plurality of gas inlet ports, and
an armature coupled to the shaft member; wherein the wire winding couples to the armature;
a gas exit assembly having a cylinder-shaped housing, the cylinder-shaped housing having an outer wall that forms a hollow core, wherein the outer wall having a gas inlet port through an exterior surface leading to an inner cavity;
wherein the electrical power generation assembly is rotatably positioned within the hollow core of the gas exit assembly and partially seated within the hollow core of the gas entry assembly;
wherein gas is piped in the gas inlet port of the gas entry assembly that flows into the gas inlet ports of the shaft member, the armature, and the rotating stator assembly, exiting out of the gas exit assembly to exchange heat generated by the electric power generation assembly to external parts of an electrical system.

11. A method of generating electricity comprising:
supplying a gas flow to a gas entry assembly having a first cavity;
receiving the gas flow by an electrical power generation assembly into a second cavity from the gas entry assembly, the second cavity for propagation of the gas flow to recover the heat generated by the electrical power generation assembly;
rotating the electrical power generation assembly within the gas entry assembly, wherein the heat generated by the electrical power generation assembly is transferred to the gas flow to supply a recovery gas flow; and
receiving the recovery gas flow into a gas exit assembly having a third cavity for transferring the recovery gas flow to an external power device.

12. The method of claim 11, wherein the supplying of the a gas flow comprises:
pumping gas flow into the gas entry assembly.

13. The method of claim 11, wherein the receiving the gas flow by the electrical power generation assembly comprises:
opening gas inlets within the exterior surface of the electrical power generation assembly; and
pumping the gas flow through the second cavity of the electrical power generation assembly.

14. The method of claim 11, wherein the rotating the electrical power generation assembly comprises:
retrieving the recovery gas flow; and
powering a turbine with the recovery gas flow, such that the electrical power generation assembly coupled to the turbine is rotated.

15. The method of claim 11, further comprising:
supplying the recovery gas flow to a compressor for generating compressed gas flow.
